(19) United States
(12) Patent Application Publication
(10) Pub. No.: US 2004/0143649 A1
(43) Pub. Date: Jul. 22, 2004

(54) Multiple dynamic view enabled web services

(76) Inventors: An Feng, Cupertino, CA (US); Conor P. Cahill, Waterford, VA (US)

Correspondence Address: GLENN PATENT GROUP, 3475 EDISON WAY, SUITE L, MENLO PARK, CA, 94025, US

(21) Appl. No.: 10/348,664

(22) Filed: Jan. 21, 2003

(51) Int. Cl. G06F 15/16

(52) U.S. Cl. 709/219; 709/229

(57) ABSTRACT

The invention comprises Web services in which the sharing of XML documents containing user information between Web service providers (WSPs) and Web service clients (WSCs) provides WSPs with views/filters for different levels of WSC access. Additionally, in the invention a WSC can only view the portion of a user's XML file that its WSC group is allowed to view, as a result of action of the filters on the WSP.

### BACKGROUND OF THE INVENTION

1. Technical Field

The invention relates to Web services. More particularly, the invention relates to a method and apparatus for providing multiple dynamic view enabled Web services.

2. Description of the Prior Art

FIG. 1 is a block schematic diagram showing an architecture in which Web service clients (WSCs) 10-12 that have associated Web service entry points 14 for a Web service can access an XML document comprised of physical documents for user data 16 and an XML schema 18 of the physical documents. In FIG. 1, all WSCs perform a set of operations against a single XML document for a user. Known Web Service Providers (WSPs) currently cannot offer different portions of user data, based on their business relationship. Thus, when a WSC queries a WSP for the queryable fields for a user's record, the WSP responds with all possible data fields even though a subset thereof, e.g. user name or email address, is desired according to the business relationship between the WSP and WSC.

It would be advantageous to provide Web services in which the sharing of XML documents containing user information between WSPs and WSCs provides the WSPs with views/filters for different levels of WSC access.

It would also be advantageous if a WSC can only view the portion of a user's XML file that its WSC group is allowed to view, e.g. via the filters on the WSP.

### SUMMARY OF THE INVENTION

The invention comprises Web services in which the sharing of XML documents containing user information between WSPs and WSCs provides WSPs with views/filters for different levels of WSC access. Additionally, in the invention a WSC can only view the portion of a user's XML file that its WSC group is allowed to view, as a result of the filters on the WSP.

### BRIEF DESCRIPTION OF THE DRAWINGS

FIG. 1 is a block schematic diagram showing an architecture in which Web service clients can access an XML document (prior art);

FIG. 2 is a block schematic diagram showing a multiple dynamic view enabled Web services architecture according to the invention;

FIG. 3 is a detailed block schematic diagram showing the multiple dynamic view enabled Web services architecture of FIG. 2 according to the invention;

FIG. 4 is a state diagram showing an algorithm for computing queryable/selectable node according to the invention;

FIG. 5 is a graph showing an algorithm for constructing a schema of derived views according to the invention;

FIG. 6 is a graph showing a sample of a physical XML document according to the invention;

FIG. 7 is a graph showing a sample of an external view of user data according to the invention; and

FIG. 8 is a graphshowing a sample of an internal logical view of user data according to the invention.

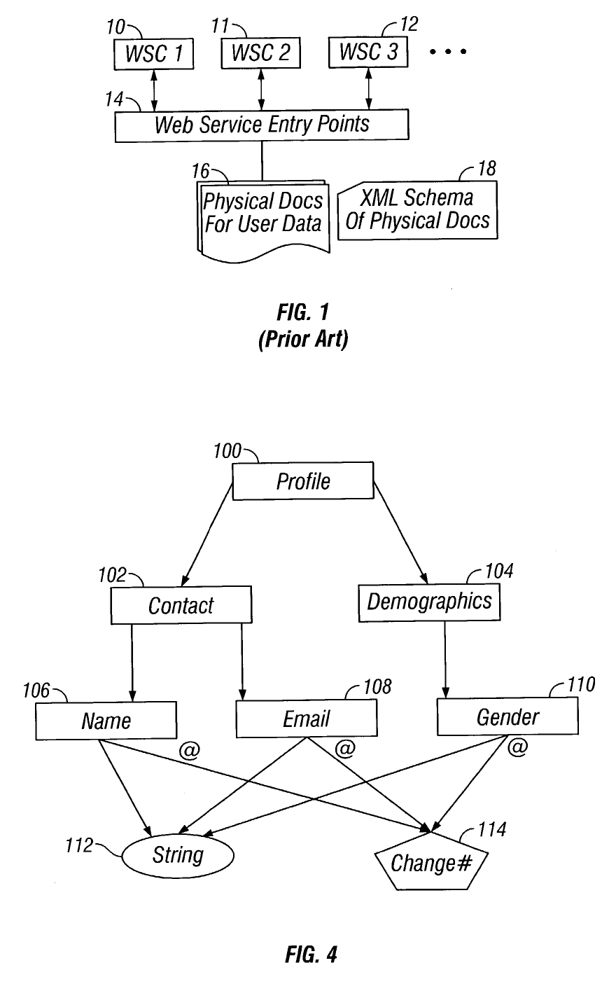

### DETAILED DESCRIPTION OF THE INVENTION

Multiple Dynamic View Enabled Web Service Architecture (Three Layers)

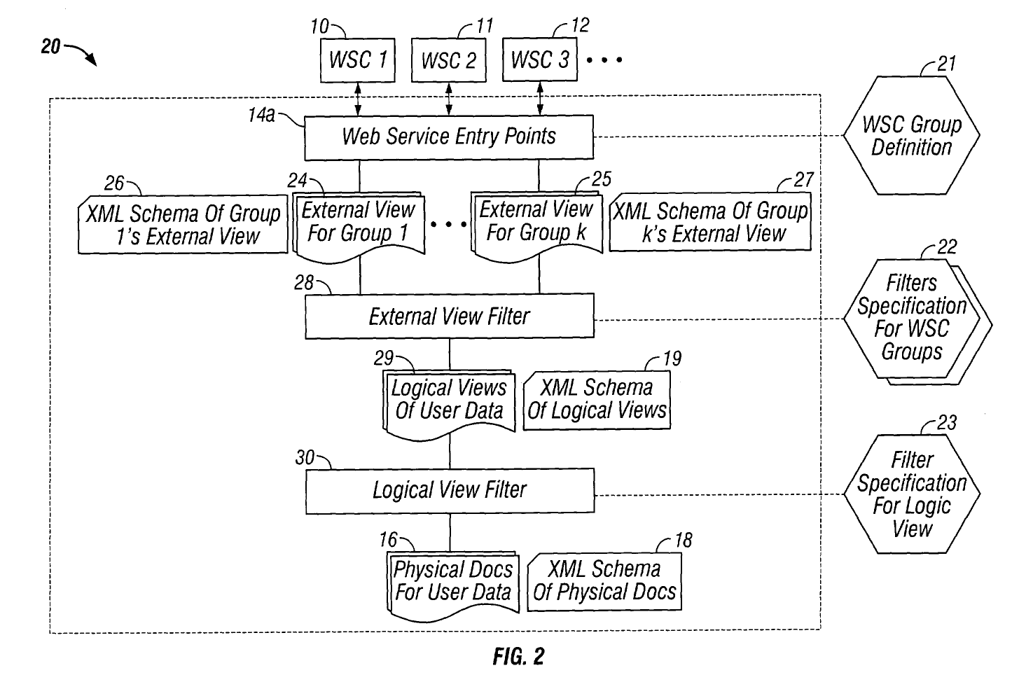

The invention comprises Web services in which the sharing of documents, which the in the presently preferred embodiment of the invention comprise XML documents, containing user information between Web service providers (WSPs) and Web service clients (WSCs) provides WSPs with views/filters for different levels of WSC access. Additionally, in the invention a WSC can only view the portion of a user's XML file that its WSC group is allowed to view, as a result of the filters on the WSP. FIG. 2 is a block schematic diagram showing a multiple dynamic view enabled Web services architecture according to the invention.

In FIG. 2, WSCs 1-3 (10-12) communicate with a three layer Web services architecture 20 via a plurality of Web service entry points 14a, which comprise a WSC group definition 21, and which further comprise a first layer of said architecture. External views are provided for a plurality of groups. In the example of FIG. 2, there are external views for external view groups 1-k (24, 25), along with an XML schema 26, 27 for each respective external view.

A second layer of said architecture is defined by an external view filter 28, which further comprises filter specifications for the WSC groups 22. The external view filter defines logical views of the user data 29, based upon XML schema of the logical views 19. Each group has a corresponding view that comprises some defined set or subset of the user data.

A third layer of said architecture is defined by a logical view filter 30, which further comprises a filter specification for the logic view 23. The logical view filter determines what portion of the physical documents for user data 16 is to be used, based upon the XML schema of the physical documents 18.

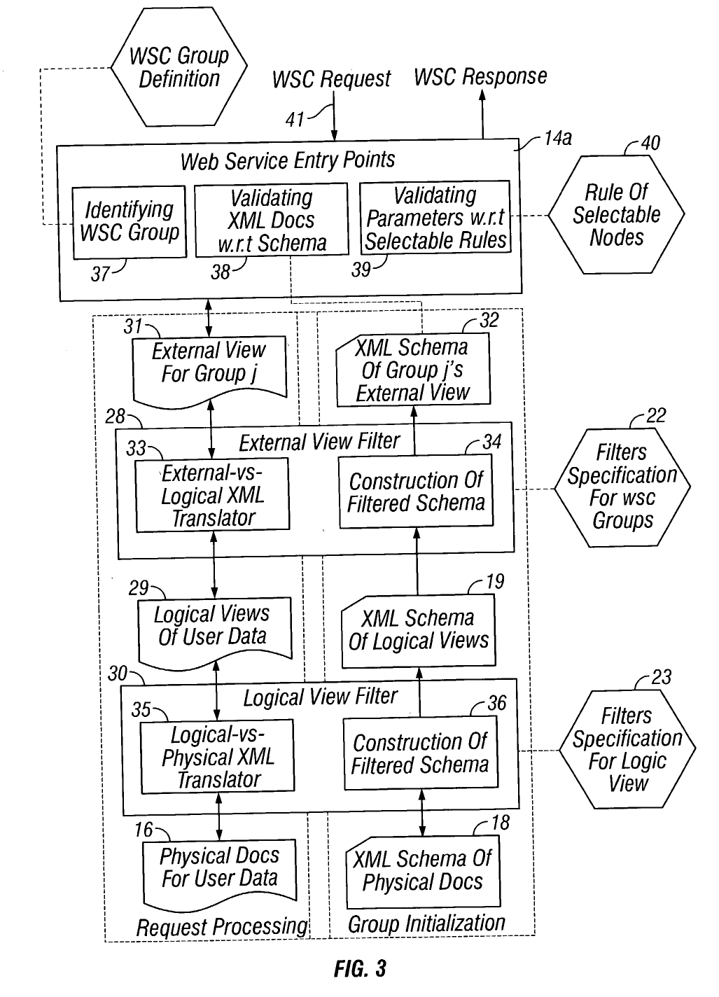

FIG. 3 is a detailed block schematic diagram showing the multiple dynamic view enabled Web services architecture of FIG. 2 according to the invention. In FIG. 3, a WSC request 41 is communicated to a first layer of the architecture 20 via the Web service entry points 14a, which comprise a WSC group identification 21 that supports a module for identifying a WSC group 37; a rule of selectable nodes 40 that support a module for validating parameters with regard to selectable rules 39; and a module for validating XML documents with regard to schema 38 (see below in connection with this latter module).

Once the WSC request is validated and group identification is established, an external view for the group 31 is determined. At the second layer, the external view filter 28 comprises an external vs. logical XML translator 33, which in turn determines a logical view of the user data 29.

At the third layer of the architecture, the logical view filter 30 uses a logical vs. physical XML translator 30 to identify the physical documents for user data 16. This completes request processing.

For group initialization, the XML schema of the physical documents 18 is determined and the logical view filter 30 employs a module for construction of a filtered schema 36 in accordance with a filter specification for the logic view 23. From the logical view filter, the XML schema of the logical views 19 is provided to the external view filter 28 for use in a module for the construction of a filtered schema 34 in accordance with a filter specification for the appropriate WSC group 22. An XML schema of the group external view 32 results, which is validated 38 and then communicated from the Web service entry points 14a as the WSC response 42.

Different External Views for Each WSC Group, Which can be Defined by the WSP Via a Configuration File

The portion of this document below entitled “Sample Of External View Of User Data” illustrates an external view for a non-affiliated WSC group. The portion of this document below entitled “A Schema For External Views” is the schema for such external views.

Both the portion of the document below entitled “Sample Of External View Of User Data” and that entitled “A Schema For External Views” only include those user data that are available for general WSCs that are not non-affiliated with the WSP. In the preferred embodiment, implementation details (e.g. @creator and <subscription>) are not exposed. Neither target marketing data nor corporate email address information is exposed.

Internal Logical View of User Data, Which Contains the Full Set of User Data

The portion of this document below entitled “Sample Of Internal Logical View Of User Data” illustrates an internal view, and that portion of this document below entitled “A Schema For Internal Logical Views” illustrates its schema. Note that in these documents/schema implementation details (e.g. @creator and <subscription>) are not exposed.

Physical View of User Data, Which Contains Both Logical Data and Implementation

The section below entitled “Sample Of Physical XML Documents” illustrates an internal view; and the section below entitled “Schema For Physical XML Documents” is its schema.

XPath Based Definition for Dynamically Computing Selectable/Queryable Nodes

The definition of selectable/queryable nodes consists of one or more of the following XML elements:

<selectable xpath=“ . . . ”> for specifying what nodes are selectable

<queryable xpath=“ . . . ”> for specifying what subnodes are queryable for a given selected node

### EXAMPLE 1

definition of selectable/queryable nodes for the herein examples:

<selectable xpath=“//*[use(@changeNumber)=required]”>
<queryable xpath=“./@changeNumber”>
<queryable xpath=“./text( )”>

Algorithms for Computing Queryable/Selectable Nodes

The algorithm comprises the following elements:

Input:

A schema of external views, such as shown in that portion of this document below entitled “A Schema For External Views”; and

An XPath based definition of selectable/queryable nodes (see above).

Output:

A list of basic XPath expressions which could be used as input parameters at Web service entry points, e.g.

“Select” parameter of Subscribe

Basic Approach:

Represent XML schema as a state diagram whose nodes represent XML element or attribute name, and edges are associated with “/” for children, “@” for attributes.

Match nodes with XPath through diagram traversal.

### EXAMPLE 2

FIG. 4 illustrates a state diagram for XML Schema given below entitled “A Schema For External Views”. In FIG. 4, a profile 100 comprises contact information 102, such as name 104 and email address 108; and demographic information 104 such as gender 110. From this diagram and the <selectable>/<queryable> definition given in Example 1, our algorithm produces the following list of acceptable basic XPath expressions.

/Profile/Contact/Name
/Profile/Contact/Name[@changeNumber]
/Profile/Contact/Name[text( )]
/Profile/Contact/Email
/Profile/Contact/Email[@changeNumber]
/Profile/Contact/Email[text( )]
/Profile/Demographics/Gender
/Profile/Demographics/Gender[@changeNumber]
/Profile/Demographics/Gender[text( )]

XPath Based Filter Definition

Each filter definition consists of one or more the following XML elements:

<hideSubtree xpath=“ . . . ”> for making a subtree invisible

<hideNode xpath=“ . . . ”> for making a node invisible

### EXAMPLE 3

Filter definition for deriving logical view from physical view:

<hideTree xpath=“//*/subscription”>
<hideNode xpath=“//*@creator”>

### EXAMPLE 4

Filter definition for deriving external view from logical view:

<hideTree xpath=“/affliation”>
<hideTree xpath=“//Target”>

Algorithms for Constructing Schema of Derived Views

The algorithm comprises the following elements:

Input:

A schema of source documents, e.g. see the section of this document below entitled “Schema for physical XML documents”; and

An XPath based filter definition.

Output:

Schema of result documents see, for example, the section of this document below entitled “A Schema For Internal Logical Views.”

Basic Approach:

Represent XML schema as a directed graph;

Apply filter rules to modify the graph; and

Derive result schema from the modified graph.

### EXAMPLE 5

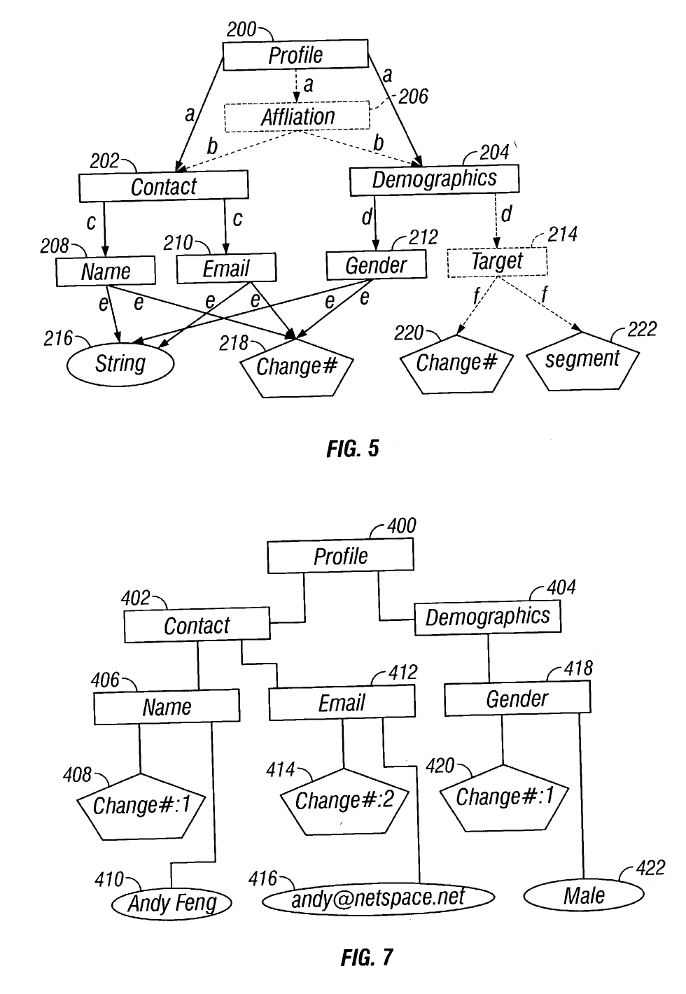

FIG. 5 is a directed diagram representing the XML schema in the section below entitled “A Schema For Internal Logical Views”. In FIG. 5, a profile 200 comprises contact information 202, such as name 208 and email address 210; and demographic information 204 such as gender 212 and target 214. The profile also includes a group affiliation 206. By applying the filter definition given in Example 4, we denote two nodes “Affiliation” 206 and “Target” 214 with dashed lines. After eliminating these nodes and their associated edges, our algorithm produces the schema in the section below entitled “A Schema For External Views”.

Web Service Entry Points that are Based on External Views

In the preferred embodiment, the following Web service entry points are based on external views:

Query: retrieve a portion of XML data specified by XPath of external views;

Insert: add new XML data by XPath of external views;

Remove: delete existing XML data by XPath of external views;

Replace: replace existing XML data (by XPath of external views) by new XML data; and

Subscribe: subscribe to the notification of XML data change, specified by by XPath of external views.

For example, Subscribe entry points take the input parameters shown in Table “A” below.

TABLE A
Input Parameters for Subscribe Entry Points

| Parameter | Value |
|---|---|
| Select | XPath expression indicating an XML element |
| | to which nodes' change should be notified. |
| BaseChangeNumber | The changeNumber the participant knows |
| | about |
| notification_mode | A flag indicating whether the notification |
| | includes the new data or only the fact that |
| | something has changed is reported. |
| notification_time | Instantly after change |
| | Batch mode in a specified date/time |
| | (such as, every midnight, or every one |
| | hour) |
| notification_to | The destination of subscriptionResponse |
| | messages |
| Authorization_assertion | Authorization assertion obtained by participant |
| Service_Assertion | Service assertion |
| Message ID | ID of the request message |

Sample of Physical XML Documents

A sample physical XML document is represented in pseudocode as follows:

```
<Profile>
  <Contact>
    <Name changeNumber=“1” creator=“WSC11”>Andy Feng</Name>
    <Email changeNumber=“2_”
creator=“WSC12”>andy@netscape.net</Email>
  </Contact>
  <Demographics>
    <Gender changeNumber=“1” creator=“WSC12”>Male</Gender>
    <Target changeNumber=“2” segmentation=“5”/>
  </Demographics>
  <AffliationOnly>
    <Contact>
      <Email changeNumber=“1”
creator=“WSCk1”>afeng@netscape.com</Email>
    </Contact>
  </AffliationOnly>
  <Subscription creator=“WSC11”>
    <Select>//Email</Select>
    <BaseChangeNumber>2</BaseChangeNumber>
  </Subscription>
</Profile>
```

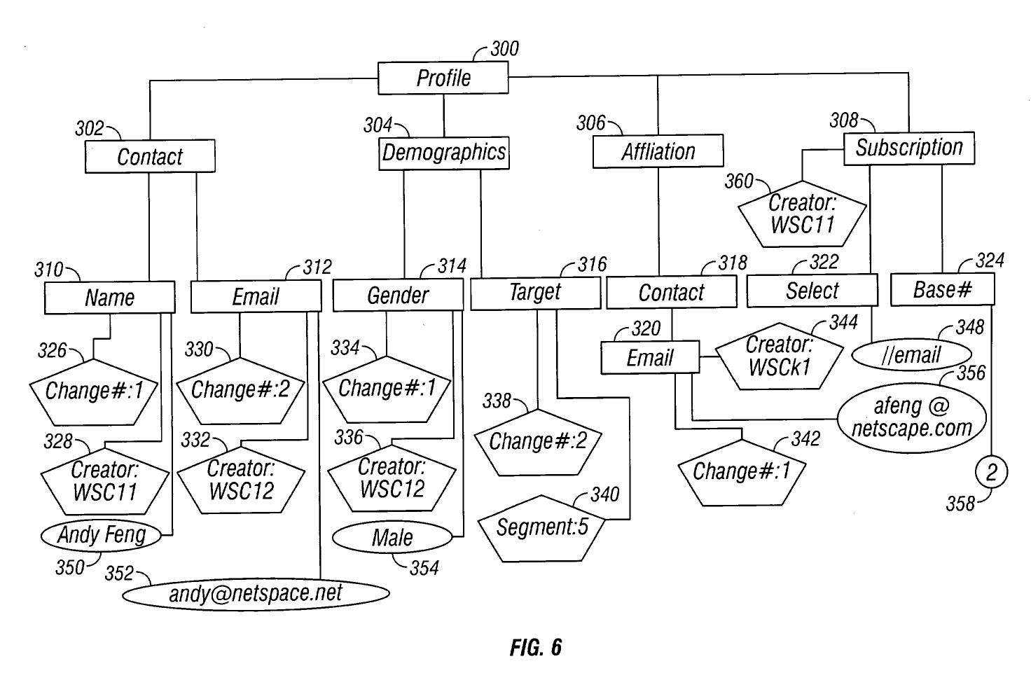

FIG. 6 is a graph representing the above physical XML document. In FIG. 6, a profile 300 is comprised of a contact 302, which comprises a name 310, which may comprise a change number 326, a creator 328, and the name itself 350; and an email address 312, which may comprise a change number 330, a creator 332, and the email address 352; demographic information 304, which comprises gender 314, which may comprise a change number 334, a creator 336, and the gender itself 354; and target 316 information, which may comprise a change number 338 and a segment 340; affiliation 306, which comprises contact 318 and email 320 information, which may comprise a change number 342, a creator 344, and the contact information 356; and a subscription 308, which comprises a creator 360, selection information 322, such as a //mail file 348 and a base number 324, such as the number “2” 358.

Schema for Physical XML Documents

The schema for physical XML documents is represented in pseudocode as follows:

```
<xs:schema xmlns:xs=“http://www.w3.org/2001/XMLSchema”
elementFormDefault=“qualified” attributeFormDefault=“unqualified”>
  <xs:element name=“Profile”>
    <xs:complexType>
      <xs:sequence>
        <xs:element name=“Contact” type=“ContactType”
        minOccurs=“0”/>
        <xs:element name=“Demographics” type=“DemoType”
minOccurs=“0”/>
        <xs:element name=“AffliationOnly” type=“AffiliationType”
minOccurs=“0”/>
        <xs:element name=“Subscription” type=“SubscriptionType”
minOccurs=“0” maxOccurs=“unbounded”/>
      </xs:sequence>
    </xs:complexType>
  </xs:element>
  <xs:complexType name=“AffiliationType”>
    <xs:sequence>
      <xs:element name=“Contact” type=“ContactType”
      minOccurs=“0”/>
      <xs:element name=“Demographics” type=“DemoType”
minOccurs=“0”/>
    </xs:sequence>
  </xs:complexType>
  <xs:complexType name=“ContactType”>
    <xs:sequence>
      <xs:element name=“Name” type=“SimpleStringType”
minOccurs=“0” maxOccurs=“unbounded”/>
      <xs:element name=“Email” type=“SimpleStringType”
minOccurs=“0” maxOccurs=“unbounded”/>
    </xs:sequence>
  </xs:complexType>
  <xs:complexType name=“DemoType”>
    <xs:sequence>
      <xs:element name=“Gender” type=“SimpleStringType”/>
      <xs:element name=“Target” type=“TargetType”/>
    </xs:sequence>
  </xs:complexType>
  <xs:complexType name=“SimpleStringType”>
    <xs:simpleContent>
      <xs:extension base=“xs:string”>
        <xs:attribute name=“changeNumber” type=“xs:string”
use=“required”/>
        <xs:attribute name=“creator” type=“xs:string” use=“required”/>
      </xs:extension>
    </xs:simpleContent>
  </xs:complexType>
  <xs:complexType name=“TargetType”>
    <xs:sequence/>
    <xs:attribute name=“changeNumber” type=“xs:string”
    use=“optional”/>
    <xs:attribute name=“segmentation” type=“xs:integer”
    use=“required”/>
  </xs:complexType>
  <xs:complexType name=“SubscriptionType”>
    <xs:sequence>
      <xs:element name=“Select” type=“xs:string”/>
      <xs:element name=“BaseChangeNumber” type=“xs:integer”/>
    </xs:sequence>
    <xs:attribute name=“creator” type=“xs:string” use=“required”/>
  </xs:complexType>
</xs:schema>
```

Sample of External View of User Data

For the above physical XML document, an external view of user data according to the invention is represented in pseudocode as follows:

```
<Profile>
  <Contact>
    <Name changeNumber=“1”>Andy Feng</Name>
    <Email changeNumber=“2”>andy@netscape.net</Email>
  </Contact>
  <Demographics>
    <Gender changeNumber=“1”>Male</Gender>
  </Demographics>
</Profile>
```

FIG. 7 is a graph representing the above external view of user data. In FIG. 7, a profile 400 comprises contact information 402, which comprises name information 406, including a change number 408 and the name 410; and an email address 412, which includes a change number 414 and the email address 416; and comprises demographic information 404, such as gender 418, which includes a change number 420 and the gender itself 422.

A Schema for External Views

The schema for external views is represented in pseudocode as follows:

```
<xs:schema xmlns:xs=“http://www.w3.org/2001/XMLSchema”
elementFormDefault=“qualified” attributeFormDefault=“unqualified”>
  <xs:element name=“Profile”>
    <xs:complexType>
      <xs:sequence>
        <xs:element name=“Contact” type=“ContactType”
        minOccurs=“0”/>
        <xs:element name=“Demographics” type=“DemoType”
minOccurs=“0”/>
      </xs:sequence>
    </xs:complexType>
  </xs:element>
  <xs:complexType name=“ContactType”>
    <xs:sequence>
      <xs:element name=“Name” type=“SimpleStringType”
minOccurs=“0” maxOccurs=“unbounded”/>
      <xs:element name=“Email” type=“SimpleStringType”
minOccurs=“0” maxOccurs=“unbounded”/>
    </xs:sequence>
  </xs:complexType>
  <xs:complexType name=“DemoType”>
    <xs:sequence>
      <xs:element name=“Gender” type=“SimpleStringType”/>
    </xs:sequence>
  </xs:complexType>
  <xs:complexType name=“SimpleStringType”>
    <xs:simpleContent>
      <xs:extension base=“xs:string”>
        <xs:attribute name=“changeNumber” type=“xs:string”
use=“required”/>
      </xs:extension>
    </xs:simpleContent>
  </xs:complexType>
</xs:schema>
```

Sample of Internal Logical View of User Data

For the sample physical XML document, an internal logical view of user data according to the invention is represented in pseudocode as follows:

```
<Profile>
  <Contact>
    <Name changeNumber=“1”>Andy Feng</Name>
    <Email changeNumber=“2”>andy@netscape.net</Email>
  </Contact>
  <Demographics>
    <Gender changeNumber=“1”>Male</Gender>
    <Target changeNumber=“2” segmentation=“5”/>
  </Demographics>
  <AffliationOnly>
    <Contact>
      <Email changeNumber=“1”>afeng@netscape.com</Email>
    <Contact>
  </AffliationOnly>
</Profile>
```

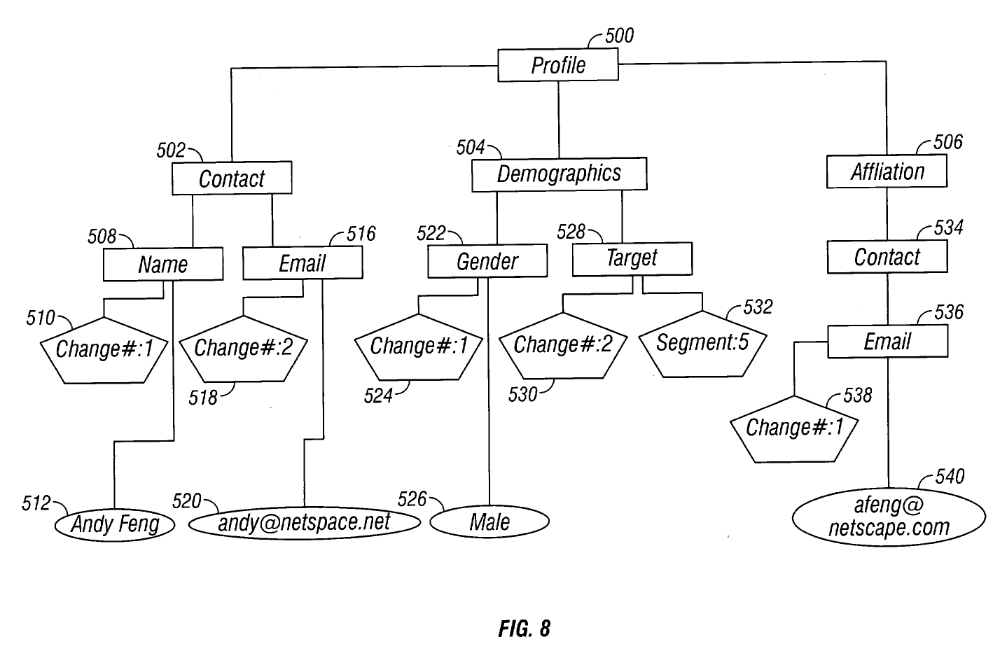

FIG. 8 is a graph representing the above internal logical view of user data. In FIG. 8, a profile 500 is comprised of a contact information 502, which comprises a name 508, including a change number 510 and the name 512; and an email address 516, including a change number 518 and the address 520; demographics 504, which comprises gender 522, including a change number 524 and the gender 526; and a target 528, including a change number 530 and a segment 532; and affiliation 506, which comprises contact information 535, including email 536, which includes a change number 538 and the email address 540.

A Schema for Internal Logical Views

The schema for internal logical views is represented in pseudocode as follows:

```
<xs:schema xmlns:xs=“http://www.w3.org/2001/XMLSchema”
elementFormDefault=“qualified” attributeFormDefault=“unqualified”>
  <xs:element name=“Profile”>
    <xs:complexType>
      <xs:sequence>
        <xs:element name=“Contact” type=“ContactType”
        minOccurs=“0”/>
        <xs:element name=“Demographics” type=“DemoType”
minOccurs=“0”/>
        <xs:element name=“AffliationOnly” type=“AffiliationType”
minOccurs=“0”/>
      </xs:sequence>
    </xs:complexType>
  </xs:element>
  <xs:complexType name=“AffiliationType”>
    <xs:sequence>
      <xs:element name=“Contact” type=“ContactType”
      minOccurs=“0”/>
      <xs:element name=“Demographics” type=“DemoType”
minOccurs=“0”/>
    </xs:sequence>
  </xs:complexType>
  <xs:complexType name=“ContactType”>
    <xs:sequence>
      <xs:element name=“Name” type=“SimpleStringType”
minOccurs=“0” maxOccurs=“unbounded”/>
      <xs:element name=“Email” type=“SimpleStringType”
minOccurs=“0” maxOccurs=“unbounded”/>
    </xs:sequence>
  </xs:complexType>
  <xs:complexType name=“DemoType”>
    <xs:sequence>
      <xs:element name=“Gender” type=“SimpleStringType”/>
      <xs:element name=“Target” type=“TargetType”/>
    </xs:sequence>
  </xs:complexType>
  <xs:complexType name=“SimpleStringType”>
    <xs:simpleContent>
      <xs:extension base=“xs:string”>
        <xs:attribute name=“changeNumber” type=“xs:string”
use=“required”/>
      </xs:extension>
    </xs:simpleContent>
  </xs:complexType>
  <xs:complexType name=“TargetType”>
    <xs:sequence/>
    <xs:attribute name=“changeNumber” type=“xs:string”
    use=“optional”/>
    <xs:attribute name=“segmentation” type=“xs:integer”
    use=“required”/>
  </xs:complexType>
</xs:schema>
```

Although the invention is described herein with reference to the preferred embodiment, one skilled in the art will readily appreciate that other applications may be substituted for those set forth herein without departing from the spirit and scope of the invention. For example, the various constituents of the profiles provided herein, the pseudocode examples; and use of XML is given only for purposes of example, and not by way of limitation. Accordingly, the invention should only be limited by the Claims included below.

1. An apparatus for providing multiple dynamic views in a web service architecture, comprising:
at least one Web service providers (WSP);
at least one user's files associated with said WSP;
a plurality of Web service clients (WSCs); and
a least one of a view and a filter associated with said WSP for different levels of WSC access to data in said at least one user's file associated with said WSP.

2. The apparatus of claim 1, wherein said filter allows a WSC to view only that portion of said user's file that an associated WSC group of which it is a member is allowed to view.

3. The apparatus of claim 1, said WSP further comprising:
a plurality of Web service entry points.

4. The apparatus of claim 3, wherein said Web service entry points further comprise:
a WSC group definition.

5. The apparatus of claim 1, said WSP further comprising:
an external view filter.

6. The apparatus of claim 5, wherein said external view filter further comprises:
at least one filter specification for at least one WSC group;
wherein said external view filter defines logical views of user data, based upon a schema of said logical views; and
wherein each group has a corresponding view that comprises a defined set or subset of said user data.

7. The apparatus of claim 1, said WSP further comprising:
a logical view filter.

8. The apparatus of claim 7, wherein said logical view filter further comprises:
a filter specification for a logical view;
wherein said logical view filter determines what portion of a physical document for said user data is to be used, based upon a schema of said physical document.

9. A multiple dynamic view enabled Web services architecture, comprising:
at least one Web service provider (WSP);
at least one user file, associated with said WSP, containing user data;
a plurality of Web service clients (WSCs), said WSCs having a group affiliation;
a plurality of Web service entry points at said WSP for receiving a WSC request;
a WSC group identification module at said WSP for identifying a WSC group from which said request issued;
an external view filter at said WSP comprising an external vs. logical translator for determining a logical view of said user data; and
a logical view filter at said WSP comprising a logical vs. physical translator for identifying a physical document for said user data.

10. The architecture of claim 9, further comprising:
a module for construction of a filtered schema in accordance with a filter specification for said logical view.

11. The architecture of claim 9, further comprising:
a module for construction of a filtered schema in accordance with a filter specification for an appropriate WSC group.

12. The architecture of claim 9, wherein different external views for each WSC group are defined by said WSP via a configuration file

13. The architecture of claim 9, wherein an internal logical view of said user data contains a full set of user data

14. The architecture of claim 9, wherein a physical view of said user data contains both logical data and an implementation.

15. The architecture of claim 9, further comprising:
means for dynamically computing at least one selectable/queryable nodes.

16. The architecture of claim 15, wherein a definition of said selectable/queryable node comprises at least one of the following XML elements:
<selectable xpath=“ . . . ”> for specifying what nodes are selectable; and
<queryable xpath=“ . . . ”> for specifying what subnodes are queryable for a given selected node.

17. An apparatus for computing queryable/selectable nodes, comprising:
an input, comprising:
a schema of external views; and
a definition of selectable/queryable nodes;
an output, comprising:
a list of expressions which could be used as input parameters at Web service entry points;
means for representing said schema as a state diagram, comprising:
nodes; and
edges; and
means for matching nodes with a through diagram traversal.

18. An apparatus for constructing a schema of derived views, comprising:
an input, comprising:
a schema of source documents; and
a filter definition;
an output, comprising:
a schema of result documents;
means for representing said schema as a directed graph;
means for applying filter rules to modify said graph; and
means for deriving a result schema from said modified graph.

19. A method for providing multiple dynamic views in a web service architecture comprising at least one Web service provider (WSP); at least one user's file associated with said WSP; and a plurality of Web service clients (WSCs), comprising the step of:
providing a least one of a view and a filter associated with said WSP for different levels of WSC access to data in said at least one user's file associated with said WSP.

20. The method of claim 19, wherein said filter allows a WSC to view only that portion of said user's file that an associated WSC group of which it is a member is allowed to view.

21. The method of claim 19, said WSP comprising the step of:
providing a plurality of Web service entry points.

22. The method of claim 21, wherein said step of providing Web service entry points further comprises the step of:
providing a WSC group definition.

23. The method of claim 19, said WSP further comprising the step of:
providing an external view filter.

24. The method of claim 23, wherein said step of providing an external view filter further comprises the step of:
providing at least one filter specification for at least one WSC group;
wherein said external view filter defines logical views of user data, based upon a schema of said logical view; and
wherein each group has a corresponding view that comprises a defined set or subset of said user data.

25. The method of claim 19, further comprising the step of:
providing a logical view filter.

26. The method of claim 25, wherein said step of providing a logical view filter further comprises the step of:
providing a filter specification for a logical view;
wherein said logical view filter determines what portion of a physical document for said user data is to be used, based upon a schema of said physical document.

27. In a Web service architecture comprising at least one Web service provider (WSP); at least one user file, associated with said WSP, containing user data; and a plurality of Web service clients (WSCs), said WSCs having a group affiliation, a multiple dynamic view enabled Web services method, comprising the steps of:
providing a plurality of Web service entry points at said WSP for receiving a WSC request;
identifying a WSC group from which said request issued with a WSC group identification module at said WSP;
determining a logical view of said user data with an external view filter at said WSP comprising an external vs. logical translator; and
identifying a physical document for said user data with a logical view filter at said WSP comprising a logical vs. physical translator.

28. The method of claim 27, further comprising the step of:
constructing a filtered schema in accordance with a filter specification for said logical view.

29. The method of claim 27, further comprising the step of:
constructing a filtered schema in accordance with a filter specification for an appropriate WSC group.

30. The method of claim 27, wherein different external views for each WSC group are defined by said WSP via a configuration file

31. The method of claim 27, wherein an internal logical view of said user data contains a full set of user data

32. The method of claim 27, wherein a physical view of said user data contains both logical data and an implementation.

33. The method of claim 27, further comprising the step of:
dynamically computing at least one selectable/queryable nodes.

34. The method of claim 15, wherein a definition of said selectable/queryable node comprises at least one of the following XML elements:
<selectable xpath=“ . . . ”> for specifying what nodes are selectable; and
<queryable xpath=“ . . . ”> for specifying what subnodes are queryable for a given selected node.

35. A method for computing queryable/selectable nodes, comprising the steps of:
providing an input, comprising:
a schema of external views; and
a definition of selectable/queryable nodes;
providing an output, comprising:
a list of expressions which could be used as input parameters at Web service entry points;
representing said schema as a state diagram, comprising:
nodes; and
edges; and
matching nodes with a through diagram traversal.

36. A method for constructing a schema of derived views, comprising the steps of:
providing an input, comprising:
a schema of source documents; and
a filter definition;
providing an output, comprising:
a schema of result documents;
representing said schema as a directed graph;
applying filter rules to modify said graph; and
deriving a result schema from said modified graph.
